(19) United States
(12) Patent Application Publication
(10) Pub. No.: US 2022/0368375 A1
(43) Pub. Date: Nov. 17, 2022

(54) SYSTEM AND METHOD FOR ENERGY TRANSMISSION AND RECEPTION FROM NEAR-FIELD ELECTROMAGNETIC WAVES

(71) Applicant: Ibbx Inovacao em Sistemas de Software e Hardware Ltda, Capivari (BR)

(72) Inventors: Luis Fernando Pigoso Destro, Mombuca (BR); William Norberto Aloise, Sao Paulo (BR); Vanderlei Goncalves, Capivari (BR)

(73) Assignee: Ibbx Inovacao em Sistemas de Software e Hardware Ltda, Capivari (BR)

(21) Appl. No.: 17/323,959

(22) Filed: May 18, 2021

(30) Foreign Application Priority Data
May 11, 2021 (BR) BR102021009151-7

(51) Int. Cl. H04B 5/00; H02J 50/20; H02J 50/80

(52) U.S. Cl. CPC H04B 5/0037; H02J 50/20; H02J 50/80

(57) ABSTRACT

A system for energy transmission and reception from near-field electromagnetic waves, the system including a transmitting subsystem and a receiving subsystem, said transmitting and receiving subsystems being configured to, respectively, transmit and receive energy from near-field electromagnetic waves. A method for transmitting and receiving energy from near-field electromagnetic waves by a system for transmitting and receiving energy from near-field electromagnetic waves.

The present invention relates to a system for energy transmission and reception from near-field electromagnetic waves.

### DESCRIPTION OF THE STATE OF THE ART

In general, transmission and reception of electromagnetic energy is an already known subject in the state of the art.

As an example is data transmission, an application widely used worldwide for various purposes, such as communication, information transmission, among others.

Nevertheless, energy transmission and conversion from electromagnetic waves into usable energy is still an object of study nowadays. Specifically, little is known on the transmission and reception of electromagnetic waves in the near field region of the electromagnetic spectrum.

Such a region is governed by physical laws that are currently not fully understood and well defined. That is, the use of such a region in applications of electromagnetic wave transmission and reception is still the object of study in several fields.

Specifically concerning energy transmission and reception from electromagnetic waves and its subsequent conversion into storable electrical energy, little is known, and few are the teachings present in the state of the art.

An important application being referred to by the present invention is the energy transmission and reception from low frequency electromagnetic waves in the near field region and its subsequent conversion into storable electrical energy.

Although little is known in the art on the operation of energy transmission and reception from electromagnetic waves at high frequencies in the near field region, the specific operation of transmission and reception of electromagnetic waves at low frequencies in the near field region is even less known and studied, with very little information present in the state of the art.

Thus, considering that such a specific operation at low frequencies can be applied worldwide in several areas of interest, the present invention provides teachings on a system and a method for transmission and reception of low frequency electromagnetic waves in the near field region, which teachings are not observed in the current state of the art.

### OBJECTS OF THE INVENTION

A first object of the present invention lies in the provision of a system for energy transmission from near-field electromagnetic waves through a transmitting subsystem.

A second object of the present invention lies in the provision of a system for receiving energy from near-field electromagnetic waves by means of a receiving subsystem.

Yet another object of the present invention resides in the provision of at least one transmitting antenna having variable impedance and at least one receiving antenna having variable impedance, which are configured to transmit and receive near-field electromagnetic waves, respectively.

### BRIEF DESCRIPTION OF THE INVENTION

The objects of the present invention are achieved by means of a system for energy transmission and reception from near-field electromagnetic waves, the system comprising a transmitting subsystem and a receiving subsystem, said transmitting and receiving subsystems being configured to, respectively, transmit and receive energy from near-field electromagnetic waves.

The objects of the present invention are also achieved through a transmitting subsystem comprising a power source, an oscillator module, a dynamic filter, an amplifier module having variable output impedance, an automatic coupler module, at least one transmitting antenna having variable impedance and a control module, wherein the power source is electrically connected to the oscillating module, which in turn is electrically connected to the dynamic filter, said dynamic filter being electrically connected to the amplifier module having variable impedance, the amplifier module with variable impedance being electrically connected to the automatic coupler module, which in turn is electrically connected to at least one transmitting antenna with variable impedance, the control module being electrically connected, simultaneously, to the dynamic filter, the amplifier module with variable output impedance, the automatic coupler module and the at least one transmitting antenna with variable impedance.

In addition, the objects of the present invention are further achieved by means of a receiver subsystem comprising at least one receiver antenna with variable impedance, a tuner module, a rectifier module, a switching module, a voltage increasing/reducing module, and a command module, wherein the at least one receiving antenna with variable impedance is electrically connected to the tuner module, which in turn is electrically connected to the rectifier module, said rectifier module being electrically connected to the switching module, which in turn is connected to the voltage increasing/reducing module, the command module being electrically connected, simultaneously, to at least one receiving antenna having variable impedance, the tuner module, to the rectifier module, the switching module and the voltage increasing/reducing module.

Moreover, the objects of the present invention are achieved by a method of energy transmission and reception from near-field electromagnetic waves through a system for transmitting and receiving energy from near-field electromagnetic waves, the method comprising the steps of transmitting an oscillatory signal in the near-field region through a transmitting subsystem and receiving and converting electromagnetic waves transmitted in the near-field region into storable energy via a receiving subsystem.

### BRIEF DESCRIPTION OF THE DRAWINGS

The present invention will now be described in more detail based on one embodiment shown in the drawings. The figures show:

FIG. 1 illustrates the transmission and reception system of the present invention;

FIG. 2 illustrates a preferred embodiment of the transmitting subsystem of the present invention;

FIG. 3 illustrates a preferred embodiment of the receiving subsystem of the present invention.

FIG. 4 illustrates in a conceptual and exemplary manner the matching of impedances of the receiving subsystem to the impedance of the wave captured by at least one receiving antenna with variable impedance.

### DETAILED DESCRIPTION OF THE FIGURES

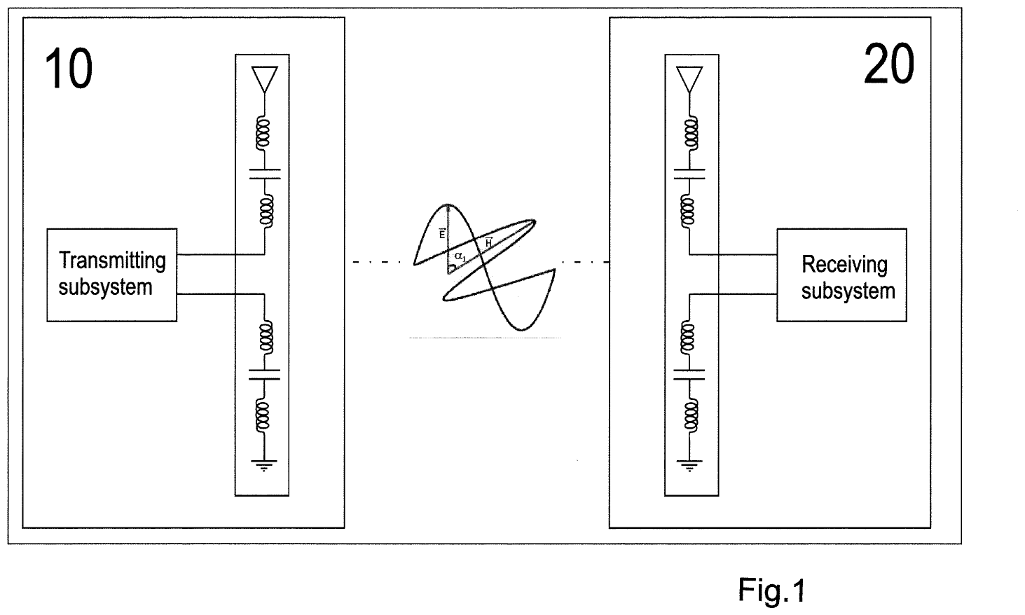

The present invention relates to a system for transmitting and receiving energy from near-field electromagnetic waves, wherein said system comprises a transmitting subsystem 10 and a receiving subsystem 20, as illustrated in FIG. 1.

The term “near-field” used throughout this document refers to a finite space-time region, more specifically a region of the electromagnetic wave field of an object that emits electromagnetic waves, such as example, a transmitting antenna. The “near-field” region is comprised between said transmitting object and another region designated as “far-field”.

In the state of the art, the boundary between the near-field and far-field regions is not precisely defined. However, the extent of such regions is known to depend on the wavelength (λ) of the electromagnetic wave emitted by the emitting object as well as its physical size.

In addition, the near-field region can be further subdivided into three additional regions: Reactive near-field (also designated as non-radiative/non-radiant near-field), radiative/radiant near-field and transition zone.

Far-field applications are extremely common in the state of the art and the behavior of electromagnetic waves in this region is already widely known and studied, particularly due to the stability that electromagnetic radiation has in such region. It is common to encounter radiation patterns from electromagnetic antennas that, by default, only consider the far-field region.

When electromagnetic waves are used in near-field applications, anomalous electromagnetic behaviors are observed, which are still poorly understood. Among others, the following can be highlighted:

Low gain, regardless of the physical size of the transmitting/receiving antennas;

Change in the impedance of the free space wave as a function of transmission/reception distances (Tx/Rx), both in the real part and in the imaginary one;

Phase difference between the electric (E) and magnetic (H) fields as a function of Tx/Rx distances;

Amount of energy distributed unevenly between fields E and H; Difference in intensity of electric field E and H components as compared to those already known in far-field; and

Low radiation resistance in electrically small antennas (ESA);

Furthermore, when applications with high frequency electromagnetic waves are used, the near-field is not desired, since the operation distances in this region are very small.

The present invention, however, relates to a system for transmission and reception of energy from electromagnetic waves, particularly at low frequencies, being applied to the near-field region. Compared to the commonly known applications of transmission and reception of electromagnetic energy in the far-field region, the present invention provides several advantageous features such as:

Higher amount of energy available to the receiving object;

More linear power density as a function of distance;

Energy available in the electromagnetic field distributed evenly 360° around the transmission plane (phi planeφ); and

Less wave attenuation when crossing barriers.

As mentioned above, the present invention is directed to a system that operates in the near-field with low frequency electromagnetic waves. By operating on such low frequencies, the aforementioned benefits can be effectively achieved.

More specifically, the present invention relates to the operation of the transmission and reception system with electromagnetic waves in the range of from 1 MHz to 150 Mhz.

It is therefore observed that the conventional calculations used for far-field applications do not work effectively in near-field applications, especially for low frequency electromagnetic waves.

In this sense, the present invention provides a system that comprises devices specially configured to operate under these conditions in order to overcome the aforementioned anomalous effects. Such devices should not be understood as a limitation of the present invention, being exemplifications chosen to illustrate an optimal and preferred operation of the system now presented.

The electromagnetic wave energy transmission and reception system of the present invention comprises two main subsystems: a transmitting subsystem 10 and a receiving subsystem 20.

The transmitting subsystem 10 is configured to transmit electromagnetic waves to the receiving subsystem 20 and the receiving subsystem 20 is configured to capture the electromagnetic waves emitted by the transmitting subsystem 10, specifically in the near-field region by converting energy from electromagnetic waves into storable energy.

Transmitter:

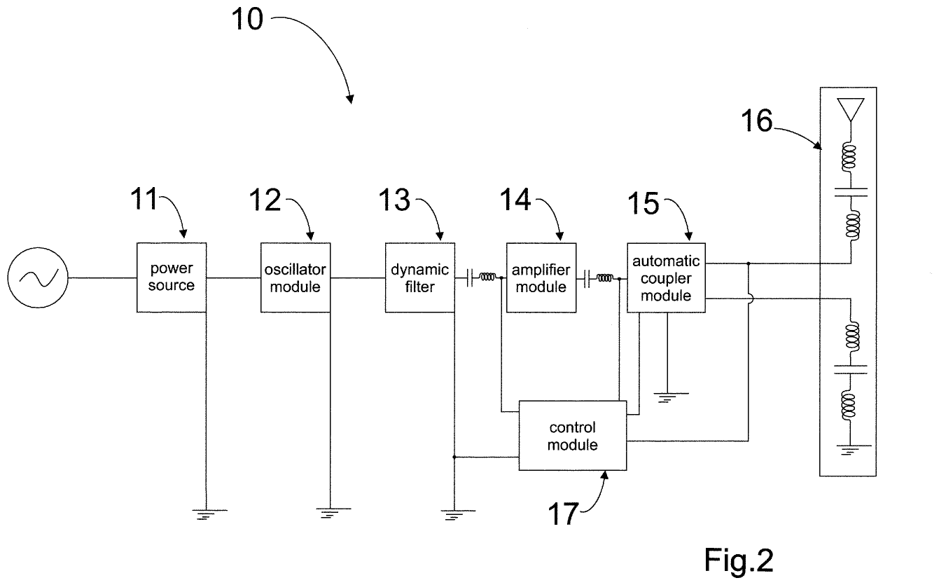

As shown in FIG. 2, the transmitting subsystem 10 comprises a power source 11, an oscillator module 12, a dynamic filter 13, an amplifier module with variable output impedance 14, an automatic coupler module 15, at least one transmitter antenna with variable impedance 16 and a control module 17.

The power source 11 is an AC/DC source, which can be either a switched power source or a linear transformation source that receives alternating current from conventional sources such as, for example, 50 Hz and 60 Hz sockets, rectifies it and supplies direct current at its output. Such a direct current is then directed to the oscillating module 12.

The oscillator module 12 generates an oscillatory signal at its output at a specific pre-defined frequency to feed the further components of the system. To this end, the oscillator module 12 can be implemented in several ways such as, for example, through common quartz crystal oscillators or pre-defined circuits such as phase locked loop circuits (PLL).

The dynamic filter 13 comprises an association of electrical components, such as resistors, capacitors and inductors, in order to configure an RLC resonant circuit. Such a configuration enables one to determine a desired working frequency according to the need of application of the device.

The dynamic filter 13 acts together with at least one transmitting antenna with variable impedance 16 and the control module 17. The dynamic filter 13 receives an electrical pulse from the transmitting antenna 16 and changes the impedance of its RLC circuit by changing the internal clock of the control module 17.

That is, changing the internal clock of the control module 17 causes the inductive and/or capacitive reactance of the RLC circuit of the dynamic filter 13 to be modified, resulting in alteration of the tuning frequency of said filter 13. Such an alteration causes the dynamic filter 13 to only allow passage of signal having the desired tuning frequency, filtering all the others.

After the signal is filtered, it is then directed to the amplifier module with variable output impedance 14. Said amplifier module 14 operates as already known in the state of the art by receiving a signal with an input voltage and, at its output, providing a signal with an amplified voltage.

Such amplification depends on several factors, such as construction components, amplifier gain, and so on. Only preferably, the amplifier module 14 of the present invention operates from 0 Watts to 50 Watts, more preferably at 10 Watts.

Also, said amplifier module having variable output impedance 14 operates together with the control module 17, such that its output impedance is controlled through the control module 17. A system of inductive and capacitive impedances is present at the amplifier module 14 output, so that, by changing the internal clock of the control module 17, the amplifier module 14 impedances are also changed.

The automatic coupler module 15 comprised in the transmitting subsystem 10 comprises a voltage comparator circuit and a plurality of electrical components such as, for example, resistors, capacitors, inductors, diodes, among others. Said automatic coupler module 15 is electrically connected to at least one transmitting antenna with variable impedance 16 and the control module 17.

Two terminals of the at least one transmitting antenna 16 are connected to the automatic coupler module 15 and at least one electrical resistor is present between each connection. More specifically, one of the terminals of the transmitting antenna 16 is connected to one terminal of the automatic coupler module 15 and between this connection is at least one of the electrical resistors. The second terminal of the transmitting antenna 16 is connected to another terminal of the automatic coupler module 15 and between such connection is at least another electrical resistor.

Arrangement of such resistors allows the voltage comparator circuit present in the automatic coupler module 15 to compare the voltage being supplied to the transmitting antenna 16 with the voltage being “returned” from the same antenna, such voltages being obtained by measuring the voltages present in the cited resistors. Thus, when the voltage returning from the transmitting antenna 16 drops significantly, relative to the voltage supplied at its input terminal, the control module 17 changes the impedance of the at least one transmitting antenna 16.

The expression “impedance of the at least one transmitting antenna 16” cited above and present throughout this document, should be understood as the equivalent impedance of a set formed by the transmitting antenna 16 per se and a plurality of electrical components, such as, for example, capacitors, inductors and resistors, which are coupled to the antenna. As already known in the state of the art, for an antenna to transmit or receive electrical signals at a desired frequency, a tuning circuit must be used. Just to exemplify such a concept, the tuning circuit is represented by a RLC resonant circuit comprising electrical associations, in series or parallel, of resistors, inductors and capacitors. Thus, by “impedance of the antenna is changed” is meant that impedance of the resonant circuit is changed and, accordingly, the equivalent total impedance of the set comprising the antenna and the resonant circuit is changed. However, such an embodiment of the resonant circuit should not be construed as a limitation of the present invention, so that any electrical composition can be used to compose the resonant circuit of the transmitting antenna 16.

Preferably, the control module 17 changes the impedance of the transmitting antenna 16 when the antenna return voltage drops by more than 10% over the voltage supplied to the antenna. Impedance of the antenna 16 can be changed in different ways depending on its construction characteristics. Only preferably, impedance of the at least one transmitting antenna 16 is changed by modifying the capacitance and/or inductance of the electrical components present in the automatic coupler module 15, hence, changing the equivalent impedance of the transmitting antenna 16.

In this instance, and only preferably, the change in capacitance of the transmitting antenna 16 is carried out by changing the voltage of a plurality of varicap-type diodes present in the automatic coupler module 15. The control module 17 is configured to vary the voltage of the plurality of varicap diodes, which in turn changes the assembly capacitance.

Inductance is changed by changing the internal clock of the control module 17. As already known from the state of the art, impedance of an inductor element is obtained as a function of the frequency of the alternating electrical current passing through it. Thus, changing the oscillation frequency of the signal from the control module 17 (internal clock) causes inductance of the inductor element to also be changed.

Accordingly, the automatic coupler module 15 together with the transmitting antenna 16 and the control module 17 configure a loop operation. For such a “loop” operation to take place, a comparator element is integrated into the control module 17. Such a comparator element is configured to calculate the reflected power of the system, that is, a ratio between the power transmitted by the transmitting antenna 16 and the power that is reflected back to the transmitting subsystem 10.

By way of example only, the comparator element of the control module 17 is a Standing Wave Ratio (SWR) comparator. That is, if the voltage drops more than 10%, when voltage that returns from the transmitting antenna 6 is compared with the voltage with which it is fed, which comparison is made by the voltage comparator circuit of the automatic coupler module 15, the control module 17 will act in order to change the equivalent impedance of the transmitting antenna 16 until the ratio of the voltage returned from the transmitting antenna 16 to the voltage supplied to the antenna is less than or equal to 10%. When the ratio reaches such a value lower than or equal to 10%, it can be concluded that energy in the form of alternating current electrical power delivered to the antenna is mostly radiating, with the desired minimum returning to the transmitting subsystem 10.

The transmitting antenna having variable impedance 16 comprised in the transmitting subsystem 10 is, preferably, only an electrically small antenna (ESA). Such antennas are obtained when the physical length of the antenna is smaller than the wavelength of the wave propagated in free space. More specifically, the transmitting antenna 16 is an electrically small antenna (ESA) when the ratio of its physical size to the wavelength of the propagated wave is preferably equal to 0.1.

In operation, an electrically small antenna comprises radiation characteristics different from other antennas such as, for example, altered gain, length and effective area, impedance and directivity. Furthermore, in the present invention, the parasitic elements of the antennas, which are commonly observed and undesired in most transmission and reception operations, are used when transmitting and receiving electromagnetic waves in the near-field. This is because such parasitic elements, which represent additional reactances to the system as a whole, are compensated by the reactances observed in transmission and reception operation in the near-field.

Thus, the transmitting antenna with variable impedance 16 of the transmitting subsystem 10 is designed and configured as an electrically small antenna (ESA), having transmission characteristics that enable high performance and high gains at low frequencies and in the near-field. The transmitting antenna with variable impedance 16 comprises a conductive material such as copper, aluminum or silver, for example. Only preferably, the conductive material of the transmitting antenna with variable impedance 16 is copper. Moreover, the transmitting antenna with variable impedance 16 comprises a substrate of an insulating material such as, for example, FR4, phenolite, PVC or ABS. Only preferably, the insulating material of the substrate is ABS.

In addition thereto and as previously discussed, the transmitting antenna with variable impedance 16 has a plurality of capacitive and inductive elements integrated therewith, which can have their impedances changed by the control module 17. Thus, it can be concluded that the transmitting antenna 16 has a variable equivalent impedance that can be changed in order to allow an optimal impedance match between the antenna itself and the wave in free space transmitted and/or received in the near-field region. It is worth noting that since the electromagnetic wave propagated in the near-field region has an impedance that changes according to the distance traveled, the transmitting antenna 16, for also having an impedance that can be changed, allows the impedance during transmission and/or reception of the electromagnetic wave in the near-field to match.

Receiver:

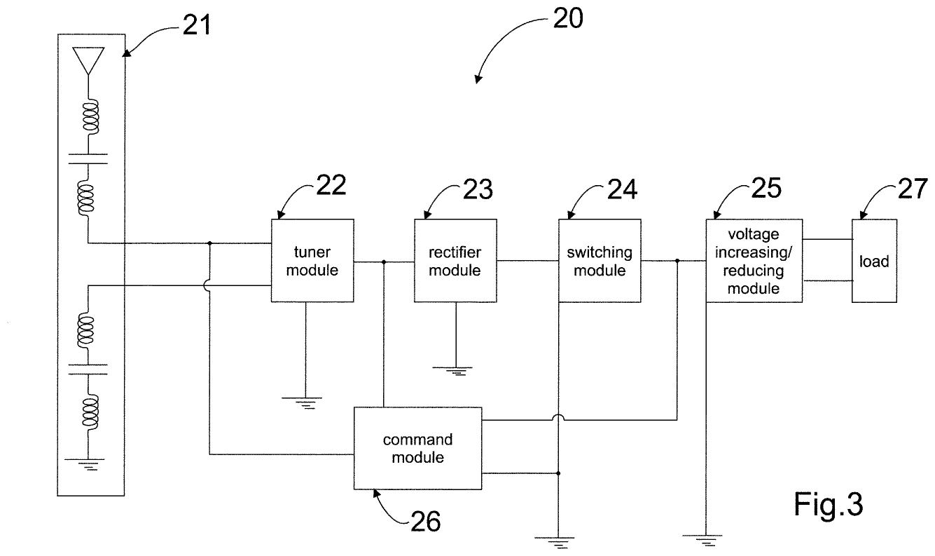

As shown in FIG. 3, the receiving subsystem 20 comprises at least one receiving antenna with variable impedance 21, a tuner module 22, a rectifier module 23, a switching module 24, a voltage increasing/reducing module 25 and a command module 26.

In terms of construction, the receiving antenna with variable impedance 21 is identical to the transmitting antenna with variable impedance 16. That is, it is an antenna comprising a conductive material such as copper, aluminum or silver. Only preferably, the conductive material of the transmitting antenna with variable impedance 16 is copper. Moreover, the transmitting antenna with variable impedance 16 comprises a substrate of an insulating material such as, for example, FR4, phenolite, PVC or ABS. Only preferably, the insulating material of the substrate is ABS.

In this sense, the receiving antenna 21 operates similarly to the transmitting antenna 16, with the main difference being in the mode of operation. While the transmitting antenna 16 is configured to transmit oscillating signals in the near-field, the receiving antenna 21 is configured to tune and capture such oscillating signals in the near-field.

As previously mentioned, an oscillatory signal has variable impedance as a function of the traveled distance, wherein such a variation is greater when the electromagnetic wave is in the near-field region. In order to automatically match the impedance of the receiving subsystem 20 to the captured electromagnetic wave, a tuner module 22 and a command module 26 are electrically connected to the receiving antenna 21.

The tuner module 22 comprises a plurality of electrical components such as, for example, resistors, capacitors, inductors, diodes, inductive and capacitive components such as bent wires, metamaterials, and the like. Impedances of these electrical components can be changed by the command module 26. There are several ways to change the impedance of inductive and capacitive components. Just as an example, capacitance of a set of varicaps diodes can be modified by changing the voltage at such diodes. Inductance of an inductive load bank can be changed by modifying the oscillation frequency of an electrical signal, since it inductance of an electrical component is known to be obtained depending on, among other factors, the frequency of the oscillatory signal passing therethrough.

After the electromagnetic wave is captured in the near-field by the receiving antenna 21, the tuner module 22 compares, through a comparator electrical circuit comprising therein, the voltage at its output terminals with the “open circuit voltage” of this same circuit. The optimum scenario would be the voltage at its output, corresponding to the voltage of the electromagnetic wave captured by the receiving antenna 21, to be half the output voltage in an open circuit. If this value is not achieved, the command module 26 acts to change the equivalent impedance of the tuner module 22, as previously mentioned. That is, preferably, capacitance is altered by modifying the voltage on varicap-type diodes and inductance is altered by modifying the frequency of the internal clock of the command module 26—which signal is directed to the inductive components of the tuner module 22.

Thus, a loop operation is performed, with the command module 26 adjusting the input impedance of the tuner module 22 until the voltage at its output terminals, which corresponds to the voltage of the electromagnetic wave captured by the receiving antenna 21, is numerically equal to half the open circuit output voltage. At this moment, the maximum useful power of the captured electromagnetic wave is being used, with only a minimum loss.

The captured electromagnetic wave is then directed to a rectifier module 23. Said rectifier module 23 consists of high-performance rectifier diodes and a capacitor configured to act as a filter. The rectifier module 23 receives the oscillatory signal with matching impedance through the tuner module 22 and the command module 26 and then rectifies it, providing a continuous signal at its output.

The rectified continuous signal is then directed to the switching module 24. Said switch module 24 comprises at least one capacitor and a switching circuit, which can be a solid-state, liquid, gaseous, mechanical, electromechanical circuit, among others. Only preferably, the switching circuit of the switching module 24 is a solid-state circuit, more preferably a transistor.

The rectified signal is initially stored for a period of time in at least one capacitor of the switch module 24, preferably in a circuit of capacitors associated with each other. The time that the rectified signal will be stored is defined by the command module 26, which analyzes and determines the switching frequency of the switching circuit, thus defining the frequency with which energy stored in the capacitor circuit will be released and directed to the voltage increasing/reducing module 25.

In order to assess the ideal moment to open or close the “switches” of the switching circuit, the command module 26 comprises a programming intelligence that assesses the ratio between the maximum voltage stored by the capacitor circuit, in Volts, in a shorter period of time, in seconds. The power must be switched from the switch module 24 to the voltage increasing/reducing block 25 at the voltage point or time having the greatest modulus of the ratio between said voltage and time.

The voltage increasing/reducing module 25 consists of a set of electrical circuits configured to increase and/or reduce the voltage at its inlet. Several already known circuits can be used to achieve this effect, however, only preferentially, the voltage increasing/reducing module 25 of the present invention comprises a buck-boost circuit associated with a plurality of electrical components having variable impedance, for example, resistors, capacitors, inductors, varicap-type diodes, among others, such impedances being changeable through the operation of the command module 26.

The voltage increasing/reducing module 25 receives energy stored and switched by the switch module 24 and by processing the command module 26 it determines the open voltage of this circuit and, from this voltage, the command module 26 analyzes what would be the impedance that would reduce this voltage by half, thus finding the Thevenin equivalent of the circuit, which is the condition in which there is the greatest efficiency in the energy transfer. The control block 26 then makes the decision to change the impedance of the circuit in two possible manner: it can be by changing the clock frequency of the circuit thereby changing the inductive or capacitive reactance of an inductor or capacitor internal to the circuit, or by changing the capacitance of a plurality of varicap diodes.

Accordingly, the output terminals of the voltage increasing/reducing module provide the maximum possible energy converted into storable energy, which can then be directed to a load 27. Such a load 27 can be understood as a battery or a battery assembly. as well as any powered device, for example, a cellular device, an electrical equipment, a lighting system, etc.

Advantageously, the present embodiment of the system for energy transmission and reception from near-field electromagnetic waves allows a conversion to be made of the energy of electromagnetic waves captured in the near-field with an excellent yield, that is, with very few losses, thus obtaining the maximum energy transfer possible to be supplied and/or stored at any load 27.

By control module 17 and command. module 26 is meant electronic systems configured to analyze and process information, acting on the further components of the system according to the processed information. Since the present invention relates to the implementation of transmission, reception and conversion of energy from electromagnetic waves in the near-field, the control module 17 and the command module 26 have on board programs related to such concepts.

For the sake of example only, the control module 17 and the command module 26 can be understood as dedicated low power microprocessors/microcontrollers, which comprise components and integrated peripheral circuits configured to analyze and process information, as well as receive and transmit commands from other system components in order to allow the optimum functioning of the transmission 10 and reception 20 subsystems now described.

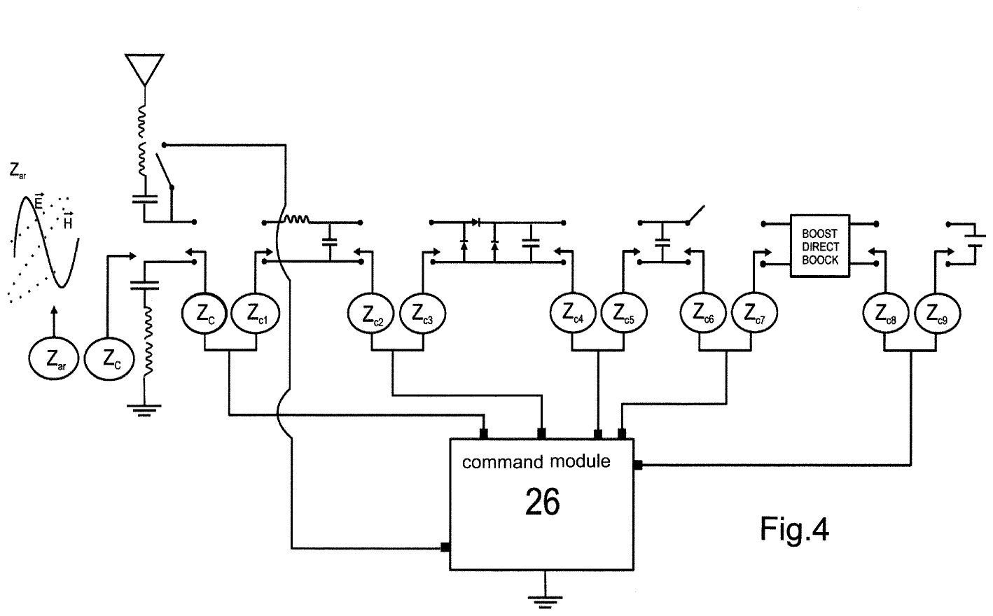

In a possible implementation of the control 17 and command 26 modules, and as previously described, they are responsible for performing continuously and automatically the impedance matching at several spots of the system, for example, between the automatic coupler module 15 and the transmitting antenna 16 and between the receiving antenna 21 and the tuner module 22. FIG. 4 illustrates conceptually and in an exemplary manner, operation of the control module 26 performing the impedance matching of the receiving subsystem 20.

As can be seen, impedances Zc−Zc₉ are matched to impedance Zₐᵣ. That is, impedances of the receiving subsystem 20 components (Zc−Zc₉) are matched to the impedance of the electromagnetic wave (Zₐᵣ) that is captured by at least one receiving antenna with variable impedance 21, thus enabling greater energy transfer to the system with minimal losses.

1. A system for transmitting and receiving energy from near-field electromagnetic waves, wherein the system comprises a transmitting subsystem (10) and a receiving subsystem (20), said transmitting subsystem (10) and receiving subsystem (20) being configured to, respectively, transmit and receive energy from electromagnetic waves in the radiative/radiant near-field region,
wherein the receiving subsystem (20) comprises:
at least one receiving antenna with variable impedance (21), configured to capture an oscillatory signal in the radiative/radiant near-field region with a frequency above 100 MHz;
a tuner module (22) configured to tune the variable impedance and the frequency in which the at least one receiving antenna with variable impedance (21) will capture the oscillatory signal;
a rectifier module (23) configured to rectify the oscillatory signal captured by the at least one receiving antenna;
a switching module (24), configured to switch the signal rectified by the rectifier module (23) into a new switched signal;
a voltage increasing/reducing module (25), configured to either increase or reduce the voltage of the switched signal;
a command module (26), configured to analyze and process information, as well as to command the other modules of the system; and
a load (27), configured to store energy provided at output terminals of the voltage increasing/reducing module (25);
wherein the at least one receiving antenna with variable impedance (21) is an electrically small antenna and is electrically connected to the tuner module (22), which in turn is electrically connected to the rectifier module (23), said rectifier module (23) being electrically connected to the switching module (24), which in turn is connected to the voltage increasing/reducing module (25), the voltage increasing/reducing module (25) being connected to the load (27);
the control module (26) being electrically connected, simultaneously, to the at least one receiving antenna with variable impedance (21), the tuner module (22), the rectifying module (23), to the switching module (24) and to the voltage increasing/reducing module (25).

2.-14. (canceled)

15. The system, according to claim 1, wherein the at least one receiving antenna with variable impedance (21) comprises at least one conductive material selected from copper, aluminum and silver, the at least one receiving antenna further comprising an insulating substrate made of material selected from FR4, phenolite, PVC and ABS.

16. The system according to claim 1, wherein the at least one transmitting antenna with variable impedance (21) is made of copper and further comprises an insulating substrate made of ABS.

17. The system according to claim 1, wherein the rectifier module (23) comprises a rectifying circuit configured to receive an oscillatory signal and provide a continuous signal.

18. The system according to claim 1, wherein the switching module (24) comprises at least one switching circuit of a type selected from solid state, liquid, gaseous, mechanical or electromechanical, said at least one switching circuit being electrically connected to at least one capacitor.

19. The system according to claim 18, wherein the switching module (24) comprises at least one solid state switching module, wherein the at least one solid state switching module comprises at least one transistor.

20. The system according to claim 1, wherein the voltage increasing/reducing module (25) is a buck-boost circuit.

21. The system according to claim 1, wherein the command module (26) comprises a microcontroller/microprocessor.

22. The system according to claim 1, wherein the load (27) comprises at least one battery.

23. A method for transmitting and receiving energy from radiative/radiant near-field electromagnetic waves comprising a frequency above 100 MHz by means of a system, wherein the method comprises the steps of:
transmitting an oscillatory signal in a radiative/radiant near-field region by means of a transmitting subsystem (10); and
receiving and converting the electromagnetic waves comprising a frequency above 100 MHz transmitted in the radiative/radiant near-field region into storable energy through a receiving subsystem (20);
wherein the step of receiving and converting the electromagnetic waves comprising a frequency above 100 MHz transmitted in the radiative/radiant near-field region into storable energy further comprises the steps of:
(a) capturing an oscillatory signal transmitted in the radiative/radiant near-field region by means of at least one receiving antenna with variable impedance (21) and a tuner module (22);
(b) rectifying the captured oscillatory signal of step (a) by means of a rectifying module (23);
(c) switching the rectified signal of step (b) by means of a switching module (24);
(d) increasing/reducing the voltage of the signal of step (c) by means of a voltage increasing/reducing module (25);
(e) finding, by means of a command module (26), an open voltage of the voltage increasing/reducing module (25), comparing the voltage of an output signal of step (d) with the open voltage of the voltage increasing/reducing module (25) and analyzing, by means of the command module (26), an optimal impedance so that the open voltage of the voltage increasing/reducing module (25) is half the voltage of the output signal of step (d);
(f) changing, by means of the command module (26), the impedance of the voltage increasing/reducing module (25) according to the optimal impedance calculated in step (e); and
(g) storing energy with an increased/reduced voltage into a load (27).

24. (canceled)

25. (canceled)

26. The method according to claim 23, wherein the step of switching the rectified signal of step (b) further comprises the step of storing the rectified signal of step (b) in at least one switching module capacitor (24) for a period of time determined by the command module (26).

27. The system according to claim 23, wherein the load (27) is at least one battery.
